(19) United States
(12) Patent Application Publication
(10) Pub. No.: US 2003/0061294 A1
(43) Pub. Date: Mar. 27, 2003

(54) Method and apparatus for digital media exchange

(76) Inventor: Michael B. Stennicke, Baar (CH)

Correspondence Address: Cowan Liebowitz & Latman, P.C., 1133 Avenue of the Americas, New York, NY, 10036, US

(21) Appl. No.: 09/781,001

(22) Filed: Feb. 9, 2001

Related U.S. Application Data
(60) Provisional application No. 60/233,771, filed on Sep. 19, 2000.

(51) Int. Cl. G06F 15/16

(52) U.S. Cl. 709/208; 709/231

(57) ABSTRACT

Users are registered in the database that identifies them as consumers or masters and/or providers or catchers. The masters prepare requests or tenders for multimedia data of particular interest, location, and time. The tender can be a one-time request or a subscription for data delivery over time. The request is sent to an exchange computing device that routs it to a particular catcher or electronically posts it. The sending and routing of the request may be performed by e-mail. The catchers respond to the request by submitting requested multimedia data to the exchange. The master then selects the submitted multimedia data. The master may also browse existing libraries of multimedia data kept at the exchange or linked to from the exchange. The master is charged and the catcher is credited with the price of data amount suggested by the catcher and accepted by the master when he/she retrieves the multimedia data.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

This invention relates to a method of exchanging computer readable files and more specifically to exchanging digital media files.

2. Description of the Background of the Invention

Internet exchanges are digital marketplaces intended for the exchange of products and services. These exchanges are either “vertical,” e.g., within the auto or the pharmaceutical industries, or “horizontal,” e.g., focused on human resources or capital equipment for any industry. Internet exchanges may be of the business to business (B2B), business to consumer (B2C), and consumer to consumer (C2C) types. For example, the Internet Capital Group has fostered a portfolio of strong B2B exchanges, Ebay.com is a successful consumer exchange and Hotjobs.com a successful hybrid. These Internet exchanges, however, deal with physical objects that have been successfully exchanged, i.e., bought and sold, before the Internet came into existence. What is still missing is a global, electronic exchange for digital multimedia data.

Until very recently, video and audio recordings were analogue. That was true, whether it was a professional studio recording or a recording by an individual consumer with a tape recorder or a camcorder. Today most multimedia recordings are digital, having formats which enable quick extraction of data. Presently available devices can record and playback digital multimedia. These devices are able to communicate with each other over short distances using wireless transmission protocols, such as Bluetooth, which description maybe found at http://www.bluetooth.com/, http://bluetooth.ericsson.se/default.asp and 802.11 described at http://standards.ieee.org/catalog/IEEE802/11.html, http://www.manta.ieee.org/groups/802/11/, and http://www.computer.org/students/looking/summer97/ieee802.htm, as well as other similar emerging protocols that use radio waves. The next generation of such devices will be addressable by an internet protocol (IP) address and will be able to communicate with other wired and wireless computing devices via cellular, third generation networks, and the Internet.

Broadband technology for enabling fast real-time multimedia transfer is quickly becoming an industry standard in cellular networks, enabling hundreds of millions of people to make digital multimedia video and audio recordings using recording equipment, including mobile phones with recording capabilities. There are millions of quasi-stationary Internet or web cams being installed around the world for highway and intersection traffic monitoring and for area and home security. Additionally, a multitude of satellites is equipped to take pictures of locations on earth and in the skies and post them on the Internet.

What is needed is an organized, demand driven, secure, electronic market place to provide an ability to exchange the digital media, and to quickly deliver it from those who are in possession to those in need of such data. Moreover, there is a need to create an open market for the digital data to dynamically establish prices that are based on the market that is transparent. Such marketplace or exchange should enable electronic transfer of multimedia data via wireless, satellite, and fixed line communication channels with a particular focus on real-time technologies wireless such as:

1. The global system for mobile telecommunications (GSM), described at http://kbs.cs.tu-berlin.de/˜jutta/gsm/js-intro.htm and code division multiple access (CDMA), described at http://www.cellular.co.za/cdma.htm, commonly known as second generation (2G) technologies;

2. The general packet radio service (GPRS), described at http://www.gsmworld.com/technology/gprs.html and enhanced data rates for GSM evolution (EDGE), described at http://www.mobilebluetooth.com/edge.htm, commonly known as 2.5 generation (2.5G) mobile technology; and

3. The universal mobile telecommunications system (UMTS), http://www.umts- forum.org/what_is_umts.html, CDMA2000, and W-CDMA, known as third generation (3G) technologies.

### SUMMARY OF THE INVENTION

The present invention allows users to be registered in a database that identifies them as consumers or masters and providers or catchers. The masters are users who may be interested in viewing, listening, or experiencing some multimedia data. The catchers are users who may be interested and able to provide the multimedia data of interest to the masters. Using proprietary or commonly available Internet browsing programs, masters prepare requests or tenders by specifying the multimedia data of particular interest, location, and time. This tender can be a one-time request or a subscription for data delivery over time.

The request is sent to an exchange computing device which routes it to at least one predetermined catcher or posts it on a page for viewing by these catchers who may be available to provide the multimedia data of particular interest. The sending and routing of the request may be performed by direct point to point messaging or via e-mail or short message system (SMS) described at http://www.gsmworld.com/technology/sms.html. The catchers respond to the request by submitting requested multimedia data to the exchange. The master is notified of the availability of the data and selects among the submitted multimedia data. The master may also browse pre-existing libraries of multimedia data maintained at the exchange or at vendors and media providers linked to from the exchange.

During the initial registration the users select preferred methods of making and receiving payments for the completed transactions, for example Visa or MasterCard can be selected. The master is charged and the catcher is credited with the price of the exchanged multimedia data. The price amount is suggested by the catcher and accepted by the master when he/she retrieves the multimedia data.

### BRIEF DESCRIPTION OF DRAWINGS

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is a pictorial representation of the environment and interconnections of various computing devices utilized in implementation of the present invention.

FIG. 2 is a block diagram of internal components of the computing devices utilized in implementation of the present invention.

FIG. 3a is a diagram representation of the interconnection of local exchange computing devices of the present invention.

FIG. 3b is a pictorial representation of the usage of pooled exchange resources.

FIGS. 4a and 4b are screen shots of different multimedia data catalogue trees of the present invention.

FIGS. 5a-5c are database record table layouts of the present invention.

FIG. 6a is a flowchart diagram of the process of the present invention used for making requests for multimedia data.

FIGS. 6b-6d are screenshots of various functionality of the graphical user interface used for requesting multimedia data of the present invention.

FIG. 7a is a flowchart diagram of a process of the present invention used for uploading multimedia data into the exchange computing device.

FIG. 7b is a screenshot of the graphical user interface for a process of the present invention used for identifying and uploading multimedia data.

FIGS. 8a and 8b are a flowchart diagram of the process of the present invention used for browsing multimedia data stored on the exchange computing device or on devices linked to the exchange.

FIGS. 8c-8e are screenshots of various functionality of the graphical user interface used for browsing exchange managed multimedia data of the present invention.

### DETAILED DESCRIPTION OF A PREFERRED EMBODIMENT OF THE INVENTION

The present invention is an exchange of digital multimedia data where users from a subset of users called masters express a desire or offer to acquire certain multimedia data by specifying offer parameters. Users from another subset of the same users called catchers accept such offer by providing the requested multimedia data, thereby creating a contract. The process can work in reverse where the catchers offer for sale the existing or stored multimedia data and live feed from stationary and mobile data recorders and the masters accept catchers' terms.

The invention enables the master to

a) Preview holiday getaway spots and facilities, determine crowd levels before visiting an establishment, such as restaurants, theaters, museums, dance halls, etc.;

b) View local traffic conditions to determine travel routes;

c) View local weather conditions, monuments, points of interest in specific locations and neighborhoods, exotic destinations, neighborhoods where you grew up; and

d) Visit theater and other performances, museums and exhibitions without queuing and avoiding crowds, this feature of the present invention is particularly enabling for the handicap.

The catcher who caters to masters' requests are compensated by

a) earning a fee when operating in the master defined session providing the live feed or a recording, whether real-time or delayed; and/or

b) building up and providing a library of multimedia data recordings accessible by masters who do not require live or custom recordings. Use of these recordings will generate a fee.

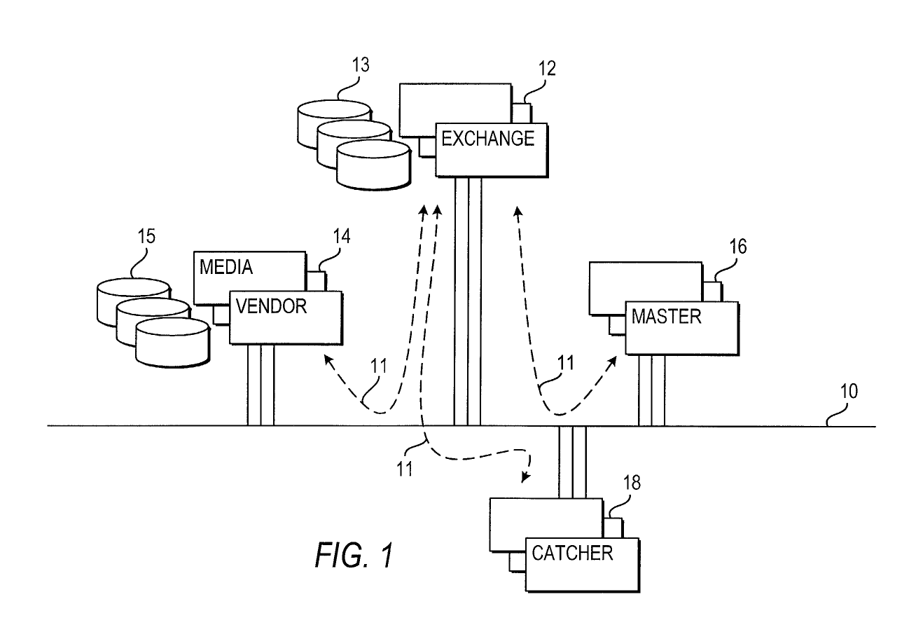

As shown in FIG. 1, the inventive system comprises computing devices 16 for use by consumers or masters requesting to see multimedia data, computing devices 18 for use by providers or catchers, as recording devices that are fixed or mobile; and computing devices 14 used by media companies that continuously produce multimedia data available for distribution and intermediary vendor entities that distribute multimedia data in the retail market. The computing devices 14, 16, and 18 are connected via physical or wireless data paths 11 over a network 10 to computing devices 12, which are used as exchanges to store, categorize, and disseminate the multimedia data. The network 10 may be any type of a network including the telephone network, the local area network, e.g., the Intranet, and the wide area network, e.g., the Internet. The computing devices 12 maintain and utilize databases 13 which include an application database for storing and matching the consumer's or master's requests with available multimedia data or/and the catchers who will provide that data.

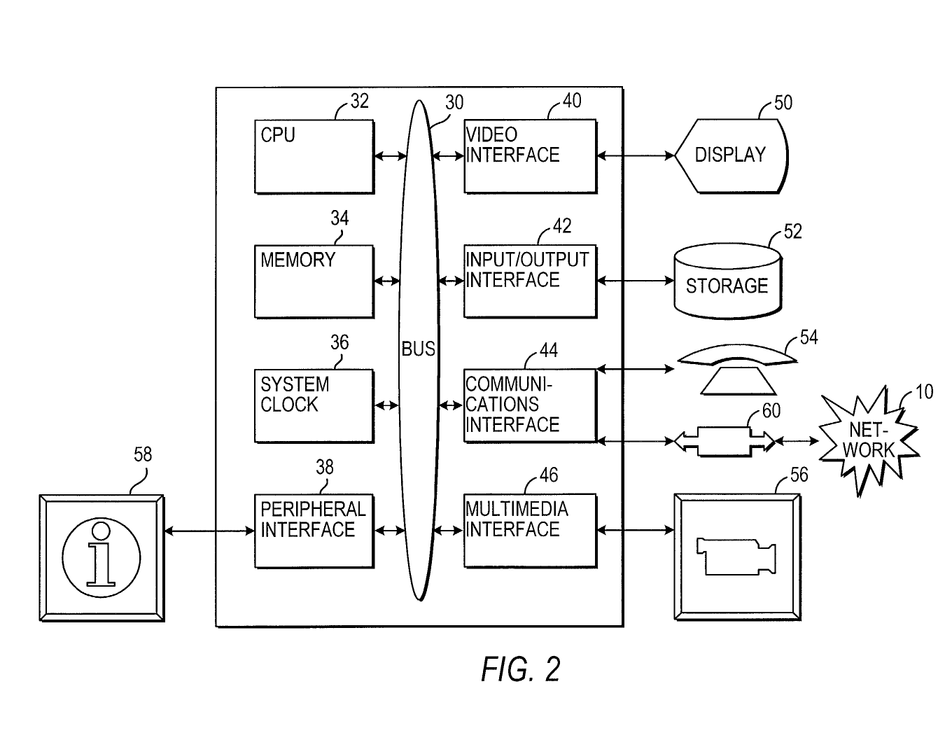

The computing devices 12, 14, 16, and 18 may take the configuration of any computer ranging from mainframes and personal computers (PCs) to digital telephones and hand held devices, e.g., palm pilotsTM. In one illustrative embodiment of this invention shown in FIG. 2, such computing devices may comprise a bus 30, which is connected directly to each of the following: a central processing unit (CPU) 32; a memory 34; a system clock 36; a peripheral interface 38; a video interface 40; an input/output (I/O) interface 42; a communications interface 44; and a multimedia interface 46.

The common bus 30 is further connected by the video interface 40 to a display 50; by the I/O interface 42 to a storage device 52, which may illustratively take the form of memory gates, disks, diskettes, compact disks (CD), digital video disks (DVD), etc.; by the multimedia interface 46 to any multimedia component 56; by peripheral interface 38 to the peripherals 58, such as the keyboard, the mouse, navigational buttons, e.g., on a digital phone, a touch screen, and/or writing screen on full size and hand held devices, e.g., a palm pilot TM; by the communications interface 44, e.g., a plurality of modems, to a network connection 60, e.g., an Internet Service Provider (ISP) and to other services, which is in turn connected to the network 10, whereby a data path is provided between the network 10 and the computing devices 12, 14, 16, and 18 (FIG. 1) and, in particular, the common bus 30 of these computing devices; and furthermore, by the communications interface 44 to the wired and/or the wireless telephone system 54.

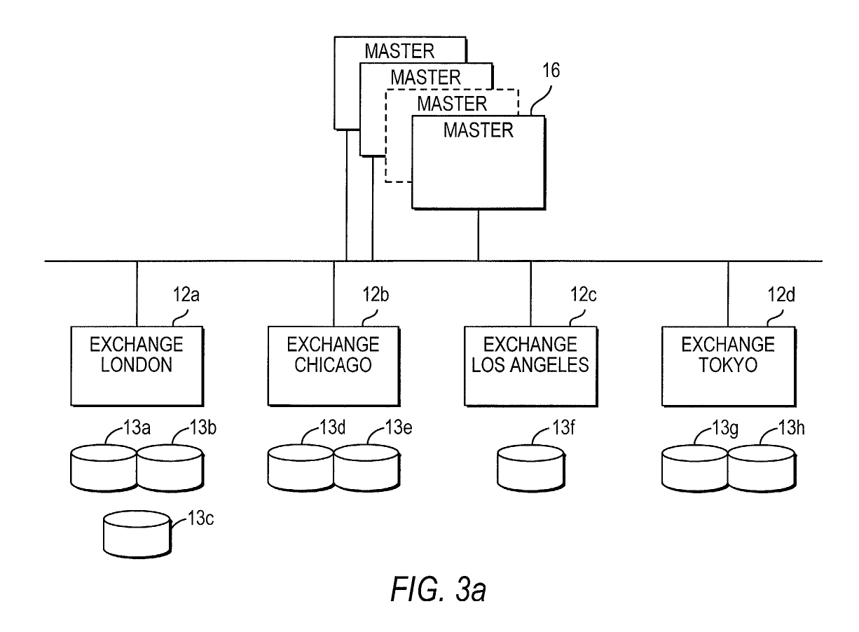

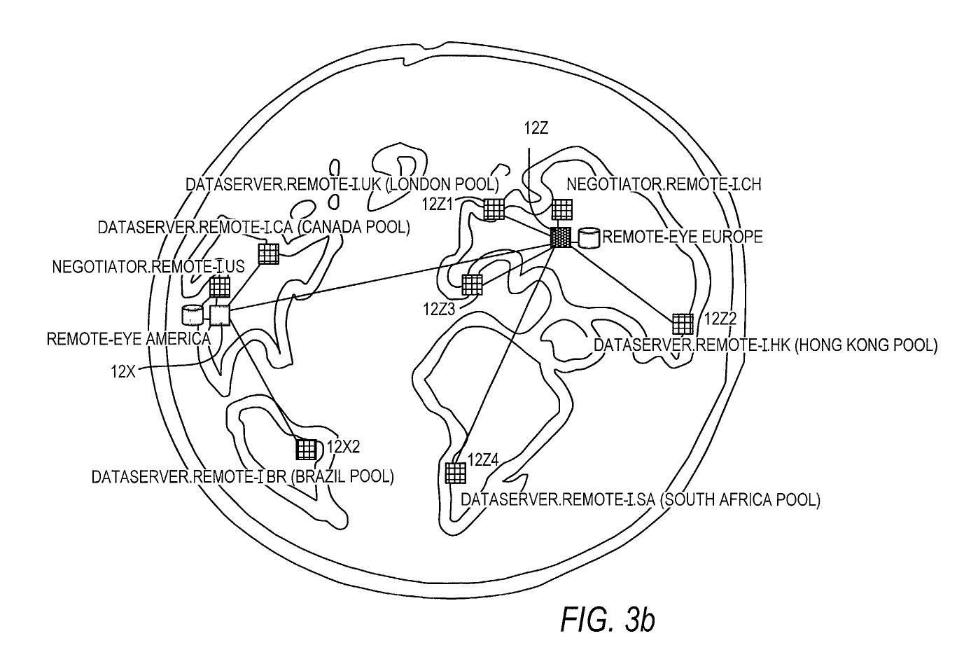

As shown in FIG. 3a, computing devices 12a-12d and databases 13a-13h represent a global network of computing and storage devices. Although they do not have to be physically located in particular geographic locations, specific computing devices may serve a particular geographic area, such as the London 12a, Berlin 12b, Los Angeles 12c, and Tokyo 12d metropolitan areas. The master, using computing devices 16 and custom or commonly used Internet browsing programs will connect to the computing device local to the master's geographic area, for example the Berlin exchange 12b. If, however, the data requested crosses political boundaries and may be found on a different exchange 12a-12d, e.g., pictures of Catharina Zeta-Jones, a Welsh Film Star living in the United States, the catalogues and services of the London and Los Angeles exchanges 12a, 12c will be made available. A central exchange, which may be any one of the computing devices 12, will manage common records in all the databases 13a-h. Any new information intended for a specific local exchange 12a-12d will be pushed or sent to the local exchange computing devices 12 and the passing of the encryption keys for the flow of traffic between the local exchanges 12a-12d will be coordinated by the central exchange. It is envisioned that all of the local exchanges can act as a distributed exchange where if one or more of the local exchanges 12a-12d is incapacitated, the functionality of the incapacitated exchanges will be carried on by active ones. One of the functions of the distributed exchange is to enable all the local exchanges to recognize users registered on other local exchanges as valid.

The user has the ability to visit and purchase the multimedia data globally, at any of the distributed exchanges 12a-12d, using a single login and name, across all systems in the world. The invention uses application presentation layers or skins to segregate different media content types into pools of content to meet expectations of diverse user populations. These pools can be presented to users in a variety of different ways. The use of application skins accommodates the needs of divergent user groups by creating perceptions of cultural propriety, because content acceptable in one culture is abhorrent in another. The appropriate pools will be shown to the users while less appropriate pools, in use in other culturally or commercially incompatible parts of the world will be hidden. The invention achieves this result while retaining a global presence and constant user base.

Please consider an example of pool usage shown in FIG. 3b. In this example there are two exchanges 12x and 12z, with six interface points each serving separate pools, i.e., Canada Pool (America) 12x1; Brazil Pool (America); 12x2; London Pool (Europe) 12zI; Hong Kong Pool (Europe) 12z2; Spanish Pool (Europe) 12z3; and South Africa Pool (Europe) 12z4. Users connect to the exchanges 12x and 12z through the network 10 (FIG. 1), with the skins or interfaces being selected according to the user's database profile.

Two separate executable skins one for American and another for European users are produced. The American users may be prevented from accessing the London Pool as it contains culturally unacceptable material, however the Hong Kong, Spain and South African pools 12z2-12z4 may be accessible.

Users

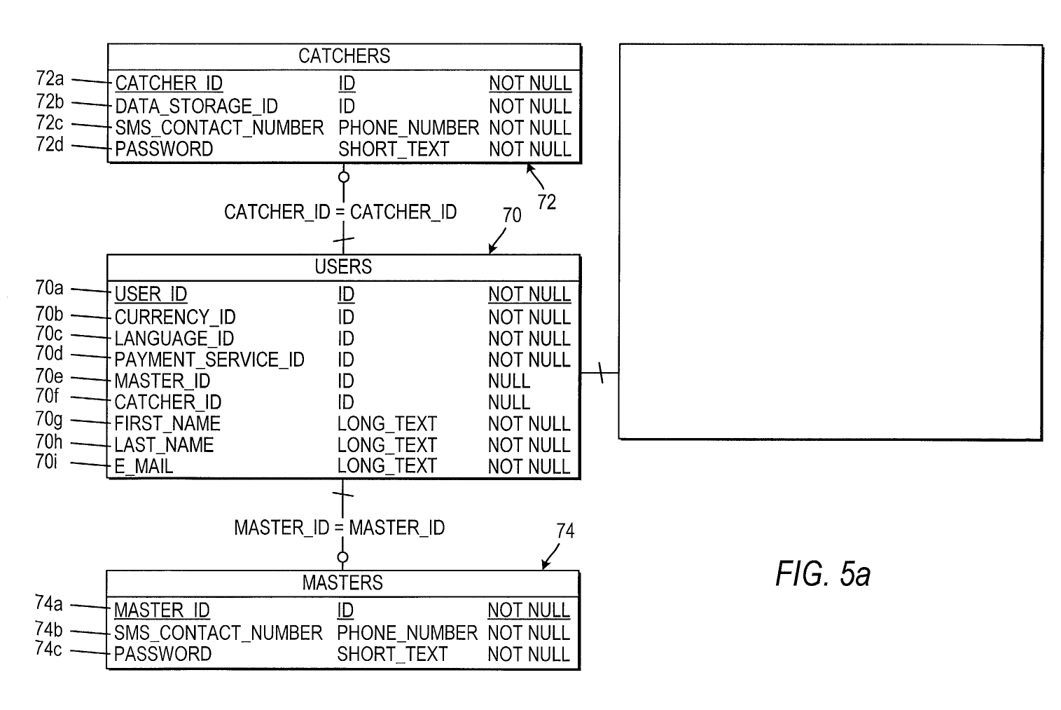

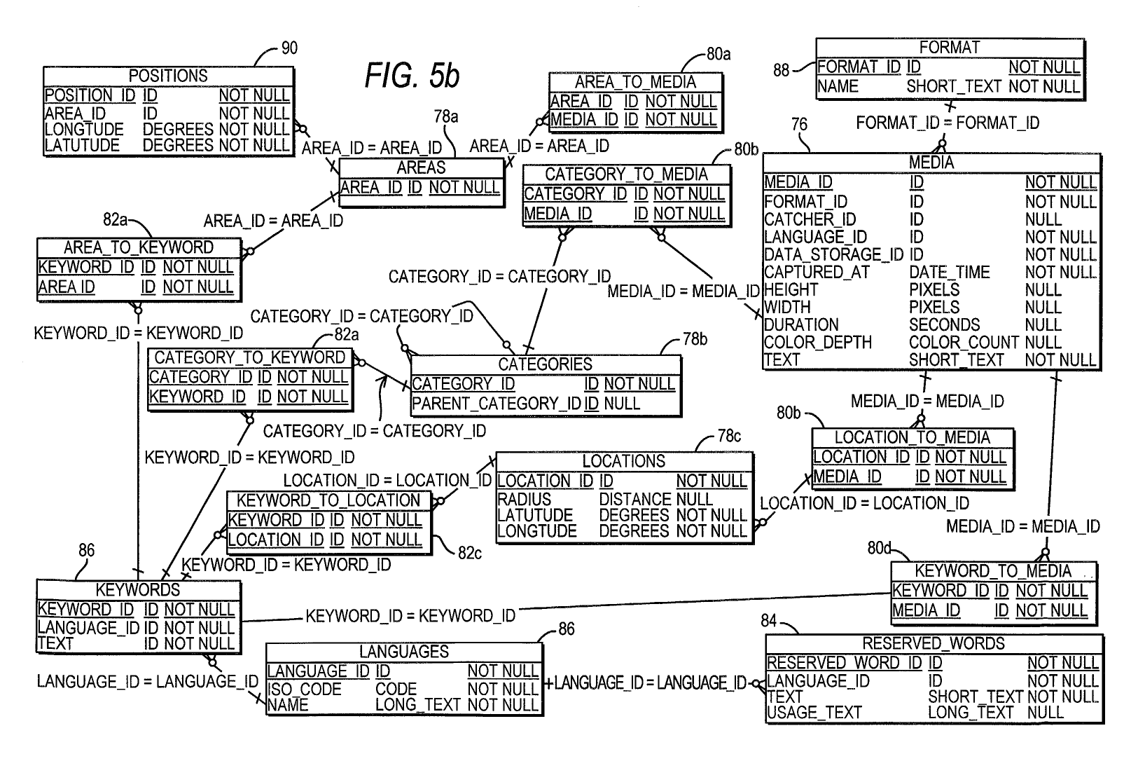

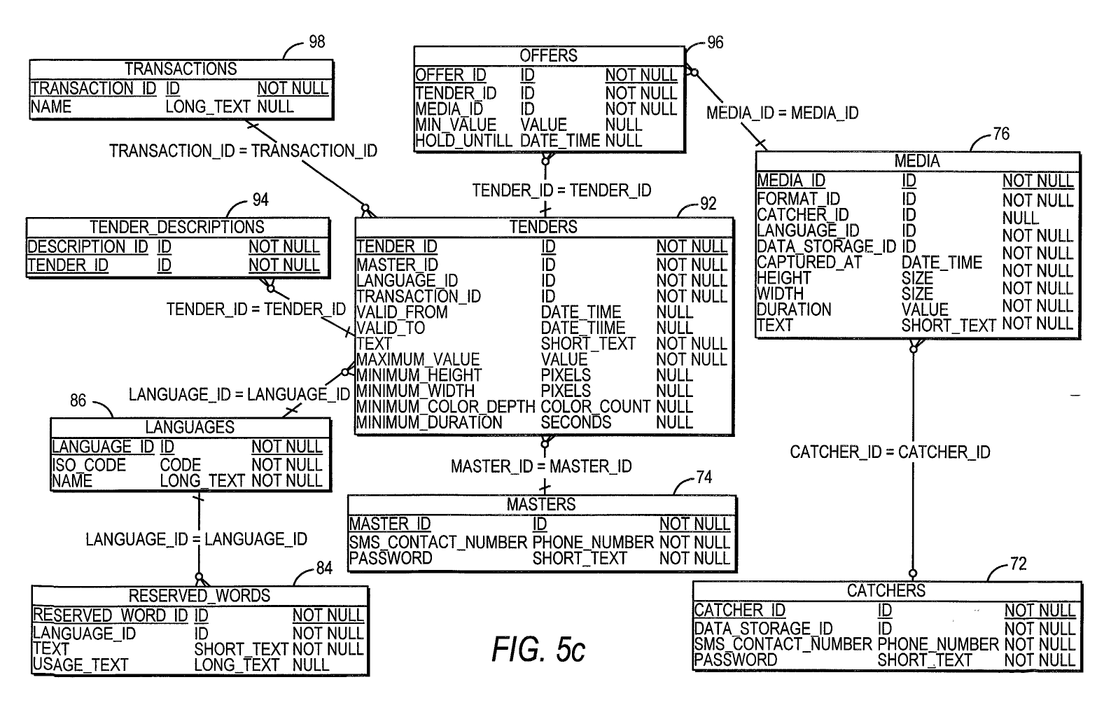

The exchange computing device 12 manages a database 13 for registering all the users participating in the exchange. All users whether requesters or providers that interact with the exchange computing device 12 are assigned a unique record having a layout shown in FIG. 5a as the users table 70. The users are uniquely identified in that table by information stored in a user id field 70a, first and last name fields 70g and 70h, and an e-mail field 70i, as this e-mail address is assumed to be unique across the world. The user's preferred currency, language, and payment methods, e.g., Visa, MasterCard or credit or debit mechanism, are recorded in fields 70b-70d.

For these users who will perform the function of the catcher, a unique value is assigned in the catcher id field 70f. In such a situation masters are registered as catchers by adding extra data to the catchers' table 72. This data identifies, in a data storage id field 72b, a storage system where images provided by the particular catcher are located. The telephone number of a non pre-paid phone that accepts SMS messages as part of the upload security process, in an SMS contact number field 72c. Additionally, the catcher is assigned or selects a password stored in an encrypted format in a password field 72d. Commonly used hash algorithms, e.g., RIPE-MD, may be used to securely code the password. In the preferred embodiment of the present invention the catcher may be required to pay a nominal subscription fee with a major credit card and the name on that credit card account will be matched with that of the phone account of the catcher. Of course it is anticipated that any other verification method can be used.

The catchers are enabled to post multimedia data on the exchange via the data paths 11. They may be required to have a user password to access this functionality, an SMS enabled number for call back authorization, and a data storage location. All the data storage locations are administered by local and/or central exchanges. Essentially, the catchers are the eyes and ears of the exchange. They provide the content or multimedia data.

It is intended that the catchers are signed up worldwide via collaboration with the network operators such as providers of the 2.5G and 3G networks and via collaboration with the recording device manufacturers. For example, when somebody somewhere takes a new subscription for a 2.5G or a 3G device or if a subscriber purchases a new 2.5G or 3G communication device, he or she will be simultaneously informed about the possibilities arising from becoming a catcher. The exchange 12 automatically detects the specific data of the catcher's recording device when the catcher logs in to download the captured multimedia data, by polling the device. This determines the quality of the data for pricing purposes.

For these users who will perform the function of the masters, a unique id value is stored in the master id field 70e of the users table 70 and in the corresponding field 74a of the masters table 74. Similar to the catchers table 72, the master may be required to enter an SMS contact number and the password values, which are respectively stored in the fields 74b and 74c. As will be described in detail below, the present invention enables the masters to post requests for multimedia data on the exchange. Such posting constitutes a first part of a contract between the master and the catcher who will undertake to provide the requested multimedia data. By requiring both the master and the catcher to pass the SMS call back security screening, as well as using a password to access the posting screens creates the necessary security and accountability for each of the contracting parties. Other security measures in addition or instead of the SMS screening can also be used.

Data

The present invention enables the masters using computing device 16 to access exchange computing devices 12 and to display multimedia recordings, such as video, audio, stills, animations, satellite broadcasts, streaming Internet broadcasts, live web cam recordings, news, financial info tickers, sports, music, artistic events, and other entertainment, in real-time or pre-recorded by catchers using computing devices 18 or vendors/media computing devices 14 from a geographical location defined by the master.

The catcher computing devices 18 may include a group of devices installed and operated from particular fixed sites having some specific attraction, such as popular venues, e.g., the Times Square, Champs Elysee, the International Space Station, exit ramps on the highways, popular theme parks, popular restaurants and discotheques, airports, mountain tops, ski resorts, exotic beaches and vacation spots, sports events, conferences, music concerts, etc. If the catcher 18 is available to provide live feed from a location requested by the master, a real-time online session can be immediately initiated between the master computing device 16 and the catcher computing device 18. If however, the catcher 18 is unavailable, a session for later execution can be arranged for the master 16 to receive either a real-time online multimedia data otherwise pre-recorded data may be viewed.

The multimedia data includes the following types:

1. Video live, real-time video, pre-recorded, or a combination of live and pre-recorded. Motion Pictures from associated media and other multimedia vendor companies in varying formats including MPEG, QuickTime, ASF, RealMedia, etc.

2. Still images, satellite pictures, and animations from various providers such as the above mentioned media and other multimedia vendor companies.

3. Audio, e.g., a live sport events, conferences, or concert currently taking place provided in collaboration with event organizers. All audio formats including MP3 are available. Where audio of a live event is requested it can be obtained using an audio enabled web cam or a 3G phone. In certain cases remote control of the web cams including audio and video zooming and angle rotation may be provided.

Multimedia data of all types, e.g., data types mentioned above, can be retrieved from the exchange by the masters or pushed to the master's computing devices 16 as part of subscription service. Customized news, sports, financial updates etc. can be sent from the media, vendors, and/or catcher's computing devices 14 and 18. This essentially represents a publishing-embodiment of the present invention where the master subscribes to receive certain data for a specific time period or per transaction.

The data is delivered to the exchange 12 and stored on the exchange storage 13 in a number of ways, through posting of e-mails including descriptions and the multimedia data attachments. Alternatively, for sensitive data there exists an interface for delivering the data encrypted. Upon delivery the data is handled according to user defmed rules. These rules may include directions on how to handle the legal ownership rights, for example, “shared rights can only be sold if exclusive rights have not been sold or have ceased to be effective.” Furthermore, the multimedia data may be processed to format display thumbnails used to entice the master to buy the original data.

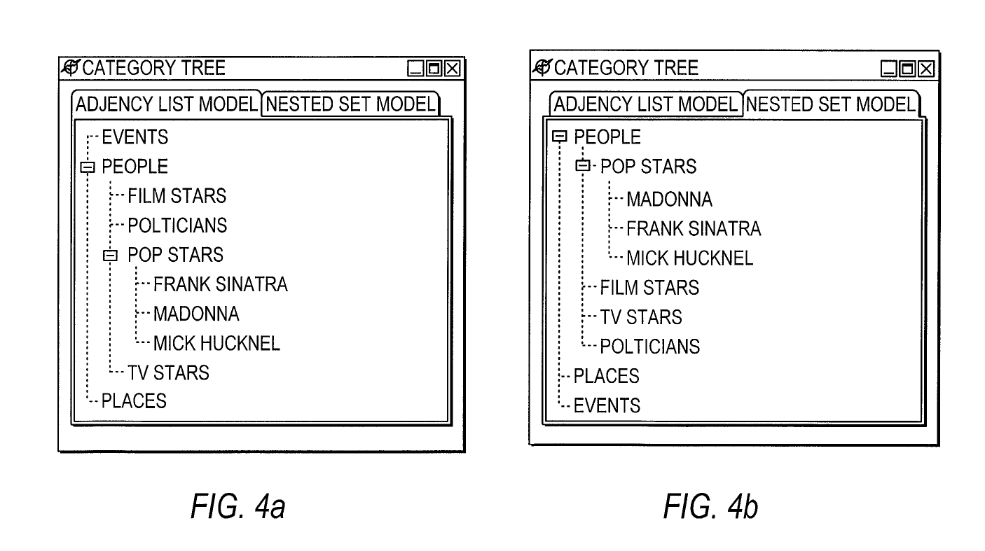

The multimedia data is catalogued in a variety of ways. In the preferred embodiment two methods of categorizing data are used, namely an adjacency list and nested set models. In the adjacency list model, shown in FIG. 4a, the data is unordered and can only be displayed in a constant order based upon some value contained within the data. An example of this is displaying the data in alphabetical order; this is sufficient for most operations. The nested set model, shown in FIG. 4b, allows the storing of sequencing information within the catalogue tree. Moreover, retrieving sequential three levels is a simple operation. An ordered catalogue tree structure can be helpful in quick retrieval of data. For example, the most popular or commonly accessed categories can be positioned at the top of the catalogue tree. Additionally, a very popular unit of multimedia data may have its own category, and that category may be placed in a fastest accessed location in the catalogue tree, even ahead of a category with thousands of multimedia units.

To catalogue the data, the invention minimizes the amount of data in the database as well as allowing flexible access paths to the data. All the words or phrases are scanned to identify phrases that include reserved or special words as these needing special processing to be performed. The words not previously encountered are added to the description list, after which the multimedia data being catalogued is associated with the new words. Thus a word like “Madonna” will only appear once in a description table but many data files will be associated with it in a one-to-many relationship. Word definitions can be entered, so that the word “London” can be associated with the geographic point 0.00E 42.34N. This way, the word “London” can be associated with numerous locations as there are several cities named London in the USA. Moreover, the word “London” could also be associated with an area bounded by several points.

After cataloguing the data in the database and storing the data, thumbnail images may be created from the original for video and picture data, and short tracks from the audio data. For faster access the thumbnails may be stored separately from the actual data. To better illustrate how the stored multimedia data is referenced, please refer to FIG. 5b. Each unit of data is defined in a media table 76 where it is assigned a unique id 76a. The data type of the data is described in an associated format table 88. As mentioned above, the media records are organized into areas, categories, locations, and according to keywords, defined in corresponding tables 78a-78d. The individual area may be further defined in the positions table 90. Each media table is then associated with the appropriate tables 78a-78d through the area to media, category to media, location to media, and keyword to media tables 80a-80d.

The keywords table 78d is associated with the area, category, and location tables 78a-78c via the area to keyword, category to keyword, and location to keyword translation tables 82a-82c. Additionally, as described above, keywords table 78d is associated with a reserved words table 84 via the languages table 86.

Making Requests

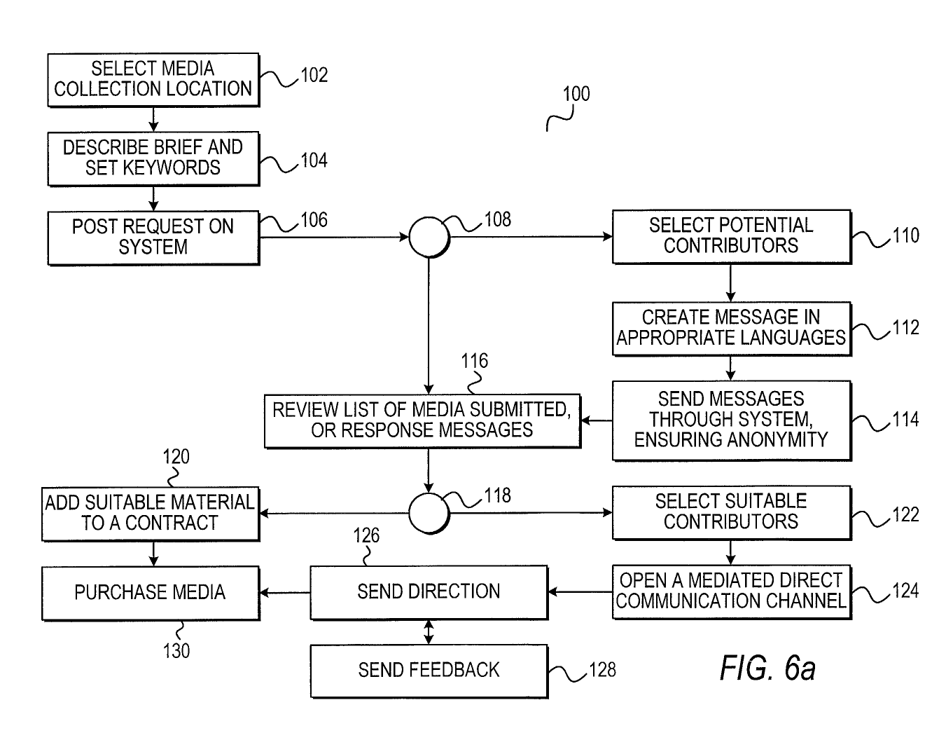

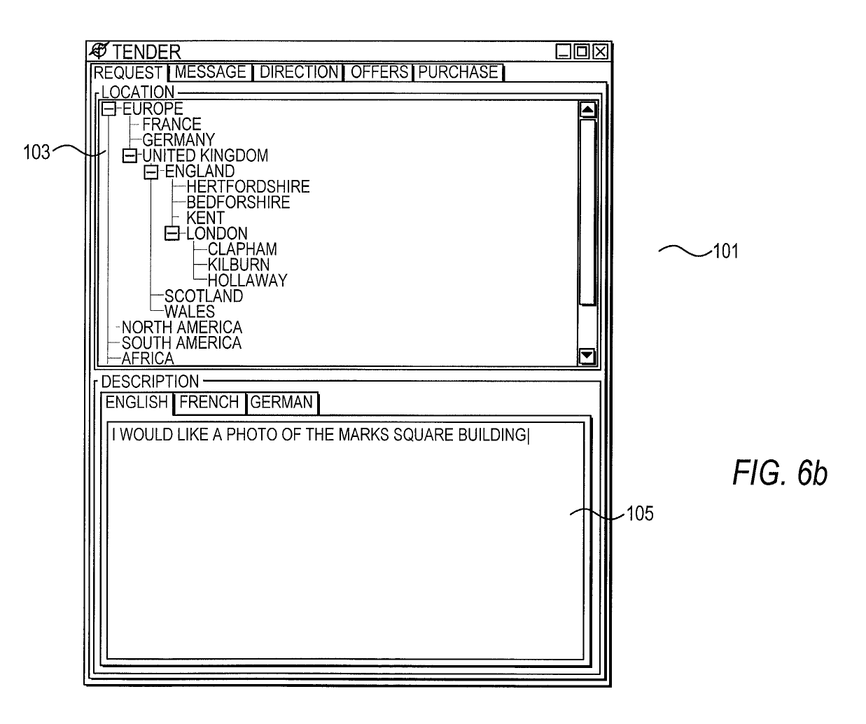

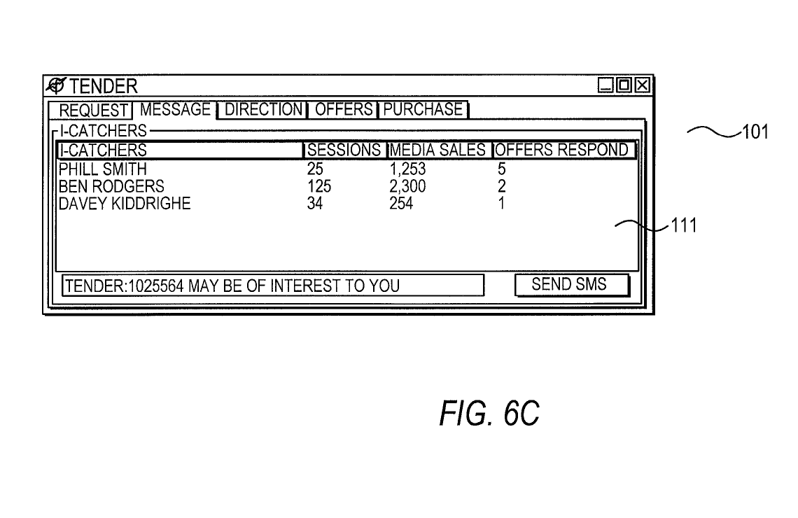

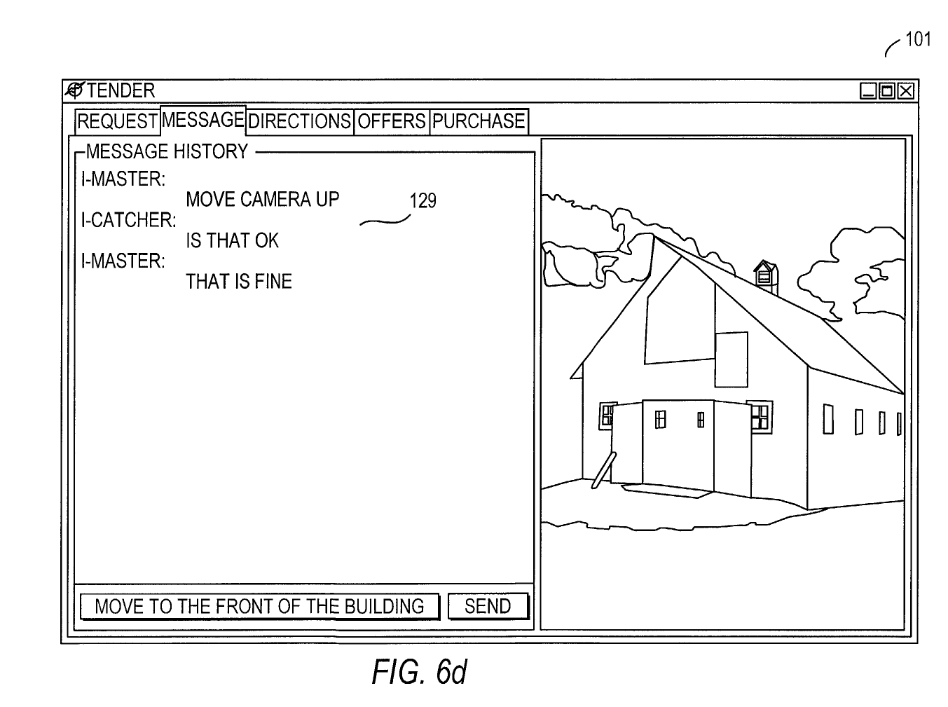

The functionality of the invention that allows the masters to request and direct the capture of multimedia data is performed by a requestor process 100 shown in FIG. 6. The requestor process 100 in step 102 allows the master to select the location of the desired multimedia data as indicated by a list 103 shown in a screenshot 103 (FIG. 6b) of the graphical user interface (GUI) 101 of process 100. Furthermore, exactly what is being requested may be described in area 105 (FIG. 6b) in step 104. This description may be provides through the use of keywords, which are described below, and in step 106 post the request in a location of the database 13 (FIG. 1) accessible by the catchers or forward the request to the designated catchers by other means, e.g., e-mail.

To post or submit the request, the master connects or logs in to the exchange's computing device 12. This step can be accomplished by access via the data path 11 from the computing devices 16 (FIG. 1). Other available communication technology, e.g., dial-up modems, cable or digital subscriber line of any type (XDSL), bidirectional satellite link using 2.5G or 3G communication device. The exchange routs the request to qualified catchers according to catcher's locations, equipment quality or some other user determined priority scheme. In situations where qualified catchers are not available to respond to the request immediately, as mentioned above, the request may be e-mailed to a group of catchers as well as placed on a publicly accessible Internet WebPages.

Referring to FIG. 5c, note that request record layout format is defined in a tenders table 92. Each request is assigned a unique id value, which is stored in the tender id field 92a. A tender description table 94 used to easily search for related tenders is defined as having a tender's description id field 94a and a unique tender id 94b field which holds the same information as the tender id field 92a of tenders table 92. The tenders table 92 is linked to the appropriate reserve words table 84 through the languages table 86. This is done to allow proper interpretation of pre-defined reserved words, e.g., see Table 3, used in the text of the request, in the language in which the request was made.

To create the request the preferred embodiment utilizes the convention described herein, however any search script creating software may be used. An inventive search protocol is designed to allow quick, effortless input of information, particularly adopted for use of handheld devices. The basic premises of the inventive protocol are as follows:

a) each line, i.e., text interrupted by a line feed (LF) or a carriage return (CR) characters, is a related set of commands;

b) each group of characters separated by a space (SP) is determined to be a meaningful word;

c) if the word contains two date separators, i.e., “/” or “.”, it will be treated as a date; and

d) if the word contains a thousand separator or decimal separator it will be treated as a value, i.e., “1,000.00” or “1.000,00.”

The preferred data and value formats may be pre-selected in the user set-up during the user registration or at any later time. The order of words on a line is unimportant to allow for ease of users of different languages having different grammar. The command words of the search protocol are presented in Table 1.

TABLE 1

| Text | Usage |
|---|---|
| Tender | Response To Specific Tenders |
| Hold | After Date Allow Tender Specific |
| | Upload To Be For Public Use |
| NoHold | |
| Copyright | Set Price Based On Copyright Transaction |
| Exclusive | Set Price Based On Exclusive Rights |
| | Transaction |
| Exclusive | Set Price Based On Temporary |
| | Exclusive Rights Transaction |
| Exclusive | Set Price Based On Temporary |
| | Exclusive Rights Transaction |
| Shared | Set Price Based On Shared |
| | Rights Transaction |
| Today | Set Date To Today's Date |
| Yesterday | Set Date To Yesterdays Date |
| Height | Set Minimum Height For Tender |
| Width | Set Minimum Width For Tender |
| Colours | Set Minimum Colour Depth For Tender |
| Seconds | Set Minimum Duration (in Seconds) |
| | For Tender |
| Key Word | To Override And Put Words In KeyWord List |
| Location | Make A Link To The Specified Location |
| Region | When There is A Choice Of Areas/Locations, |
| | They Must Be Within The Boundary Of. i.e., |
| | REGION France, AREA Paris; REGION Texas, |
| | AREA Paris. Regions Have to Have Unique |
| | Descriptions |
| Area | Make A Link To The Specified Area |
| Category | Make A Link To The Specified Category |

An exemplary search request is displayed in Table 2.

TABLE 2

| | |
|---|---|
| Madonna | Category |
| London | Area |
| Tony Blare | Keyword |
| 500.00 | Maximum Price In Deutsch Marks |
| 2000 | Minimum Height Of Photo |
| 2000 | Minimum Width Of Photo |
| COLORS 256 | Minimum Colour Depth |
| TODAY | Today = 01/11/00, Lowest |
| | Date Therefore Tender Valid From |
| 31/11/00 | Highest Date Therefore Valid |
| | Until, if One Date Always Until |

To input a query the requestor process 100 will display a form in to which a request may be entered. The query entry may be achieved using an open input query system like those used by the Internet search engines, where the use of the “and” and “or” operands is allowed in a single line of text. However this simple approach might have difficulties in distinguishing between Derby (a city in England) as a location and Derby as a sub-category of horse races (a popular horse race held near London). The single line search approach brings back all the possible combinations, often to the frustration of the user.

A multi line directed query system may allow better control over the way the words are interpreted within the system. The ambiguity between “and” and “or” operands is removed by the positioning of elements upon different lines. Two elements on a single line may constitute an “or,” where as items on separate lines indicate an “and.” The use of an “or” on a line by itself splits the query into two distinct queries, as does the placement of an “and” on a line by itself. The “or” brings back an intersection, where as the “and: brings back a combination.

To further minimize the ambiguities, the use of hint words is employed as defined in

TABLE 3

| Text | Usage |
|---|---|
| And | Combination Of Results |
| Or | Intersection Of Results |
| Not | Negation of Set |
| At | Defines as Location |
| In | Defines As Area |
| A | Defines as Category or Keyword |
| On | On a specific day |
| Between AND | Between two dates, AND is not |
| | used as combination when on the |
| | same line as a Between. The use |
| | of AND is optional |
| After | |
| Before | |
| “”or ‘’ | Make two separate words a single word |
| | with spaces in it. |

The multi lingual definition of reserved words and their use is contained in a database to allow regional exchanges 12a-12d (FIG. 3) to offer language extensions specific to their region. The query input may be achieved by typing in of a new request and selecting from previously executed requests. Additionally, on voice enabled computing devices 16 the voice commands can be accepted and translated as valid query entries.

Returning now to FIG. 6a, if in step 108, the master determines that there were no replies to his/her request, the master then selects the potential catchers in step 110, which can be done from a predetermined list or by entering identification of known catchers. FIG. 6c shows such a list 111 of catchers. If necessary, in step 112 the message to the selected catchers is translated to the appropriate language and in step 114 the message is sent directly to the selected catchers, while protecting the anonymity of the sender. The masters can communicate directly with the catchers to ask if the catchers may be willing to collect the requested multimedia data on their behalf. The catchers always retain their anonymity, and can respond if they wish to.

After the message is sent in step 114 or if there was a reply received in step 108, the requestor process 100 allows the master to review a list of the submitted multimedia data in step 116. The master reviews the submitted responses and can purchase any multimedia data uploaded. Alternatively they can select a catcher for a direct communication session while the requester process 100 ensures anonymity of both parties and monitors and records the actions. The submission of the multimedia data in response to the request is an offer to the master to purchase the data. As shown in FIG. 5c, the offer is described in the offers table 92, which is linked both to the media table 76 describing the data in question and to the actual request for that data described in the tenders table 92. The master of the request is specified in the tender associated masters table 74 and the catcher of the data is specified in the media associated catchers table 72. To distinguish occasions when identical requests are submitted by the same master, an additional transaction table 98 is created and associated with individual iterations of the requests.

Referring back to FIG. 6a, in step 118 if the master has requested a real-time viewing session and not just a file, in step 122 the master selects the contributing catcher, opens a communication channel with the catcher in step 124 and begins sending directions in step 126 and receiving feedback in step 128. An example of such session 129 is shown in FIG. 6d. Where the catcher is not immediately available, arrangements may be made to fulfill master's request and the catcher will be dispatched to make a recording or to provide a live feed at the arranged time. After the master's request is exhausted, the transaction is completed in step 130.

If in step 118 one or multiple units of canned multimedia data is selected, that is a location or an event for which a request is submitted has been pre-recorded or is presently available as a live feed, the master can view and/or hear the recording(s) immediately. Before the display of data or the dispatch take place a response to the request or tender entry is returned to the master for notification or approval in step 120, where all data for the contract completion is filled in and the multimedia data is purchased in step 130. An example of such response is shown in Table 4.

TABLE 4

| | |
|---|---|
| 452-556-885-941 | Offer To Tender 452-556-885-941 |
| 884-297-114-377 | Offer To Tender 884-297-114-377 |
| Madonna | Category Madonna |
| Tony Blare | No Category of “Tony Blare” therefore |
| | Becomes KeyWord |
| Kissing | Keyword Kissing |
| UK | Region UK, So All Areas And Locations |
| | Within Boundary |
| London | London Area, not the London Location |
| Oxford Street | “Oxford Street” Location |
| 10/11/00 | Date Taken |
| 500 | Copyright Transfer Price of £500.00 |
| 200 12/11/00 | Exclusive Rights Until 12 Nov. 2000 |
| | Price £200.00 |
| 5 1/12/00 | Shared Rights After 1 Dec. 2000 Price $5.00 |

Uploading

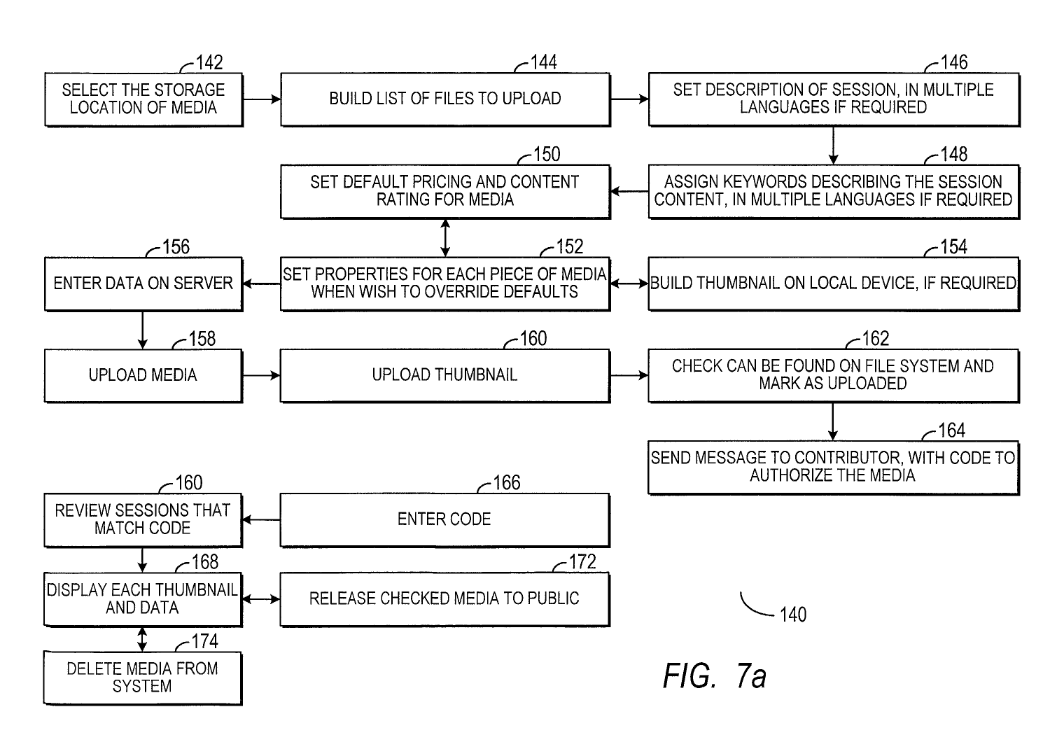

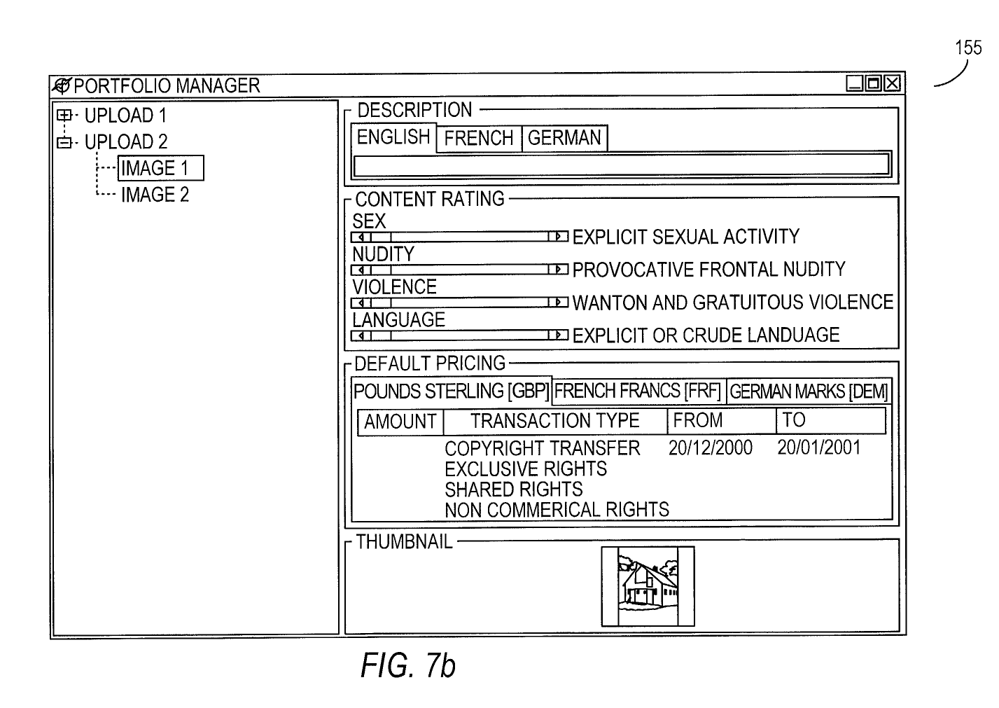

The functionality that allows the catchers to upload the multimedia data that they captured in to the database 13 (FIG. 1) is performed by uploading process 140 shown in FIG. 7a. In step 142 the catcher selects, on the computing device 18, units of the multimedia data to be uploaded to the exchange 12 and stored in the databases 13. A list of selected unit names or addresses is then built in step 144 and in step 146 the catcher is requested to give a description to the selection, i.e., describe the content of the multimedia data, for example, zoo animals. The uploading process 140 may translate this description in to one or more languages of prospective masters, and in step 148 assign appropriate keywords as described above.

Optionally, in step 150 default pricing and content rating for all units may be set. Alternatively, defaults may be overwritten in step 152 and properties of each unit may be set. In step 154 a thumbnail for each unit is built. In step 156 the list of the multimedia data to be uploaded is presented to the exchange computing device 12 (FIG. 1) together with information identifying the catcher. The description of step 146, keywords of step 148, pricing of step 150, priorities and the thumbnail of steps 152 and 154 and other information, such as sexual content rating, language, etc., are entered in to the process 140 as shown in the screenshot 155 (FIG. 7b).

In step 158 the listed multimedia data is transferred to the exchange computing device 12 followed by the thumbnails in step 160. The units may be sent immediately or in batch, i.e., queued for upload, this can be scheduled to take advantage of low tariff or reduced traffic periods. The uploading process 140 automatically deals with line problems and is able to disconnect after transfer for pay per usage connections. In step 162 after all the units are uploaded, an indicator attesting to the fact is set, followed by sending of a message, e.g., an e-mail, to the catcher in step 164.

Once the multimedia data units have been uploaded, and the catcher is notified, the catcher may login to the exchange computing device 12 to get access to the uploaded units. This may be achieved by entering some secret code, as shown in step 166. The uploaded multimedia data matching such code will be displayed to the catcher in step 168. In step 170 associated thumbnails will be displayed, as shown in FIG. 7a. If the catcher is satisfied with the review he or she may then authorize the uploaded multimedia data to be released to for sale in step 172. Alternatively, if not satisfied, all or selected units of uploaded data may be deleted.

Browser

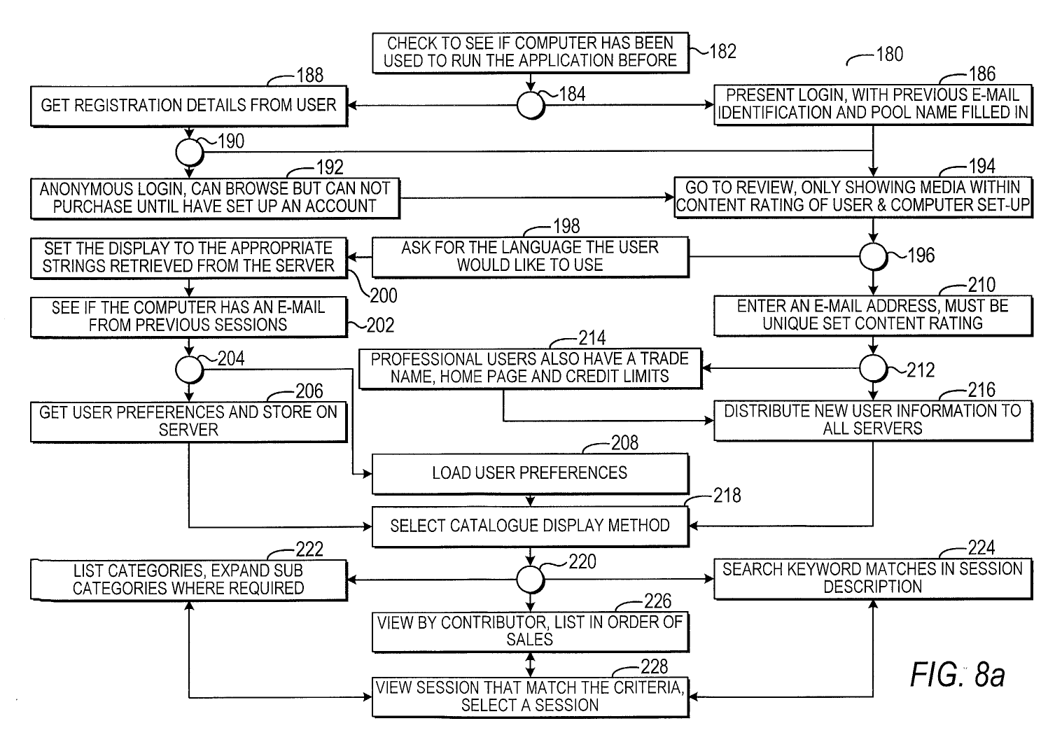

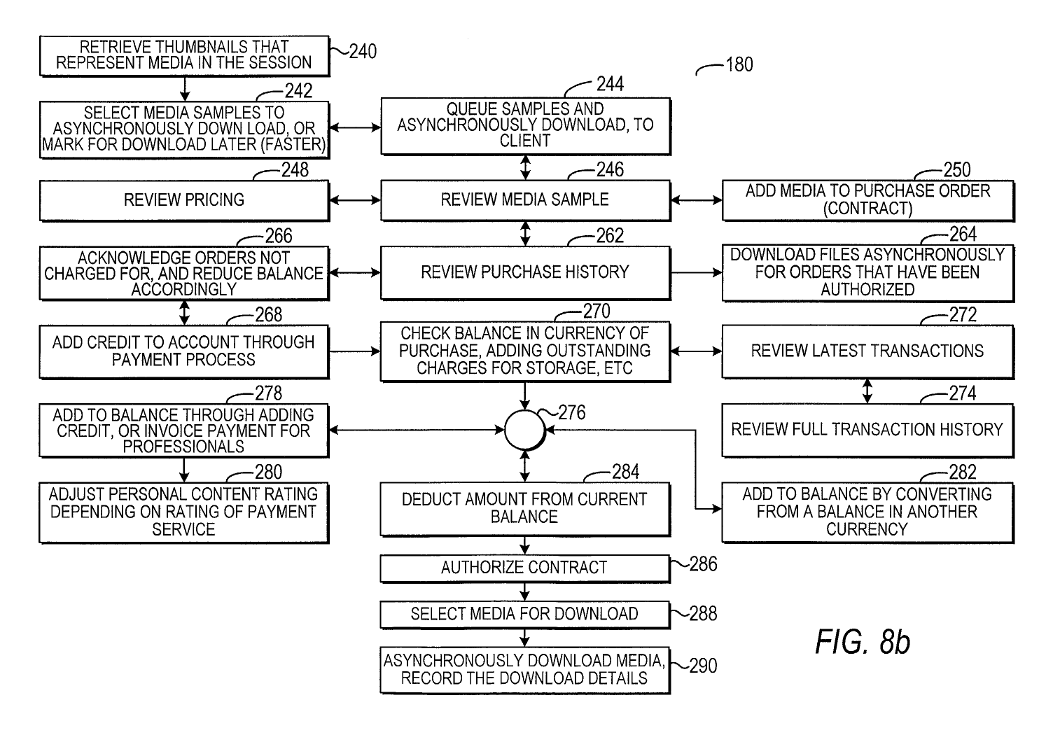

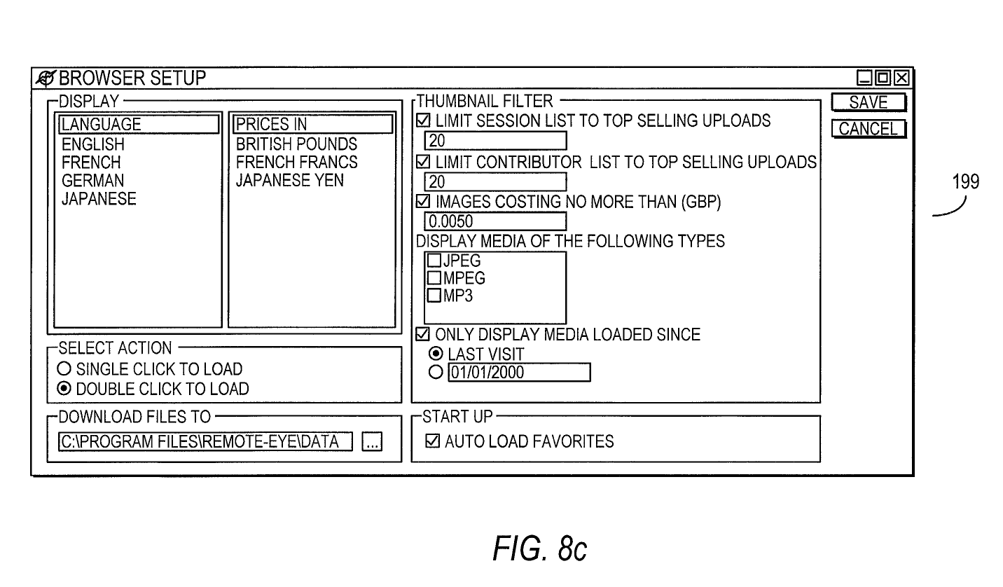

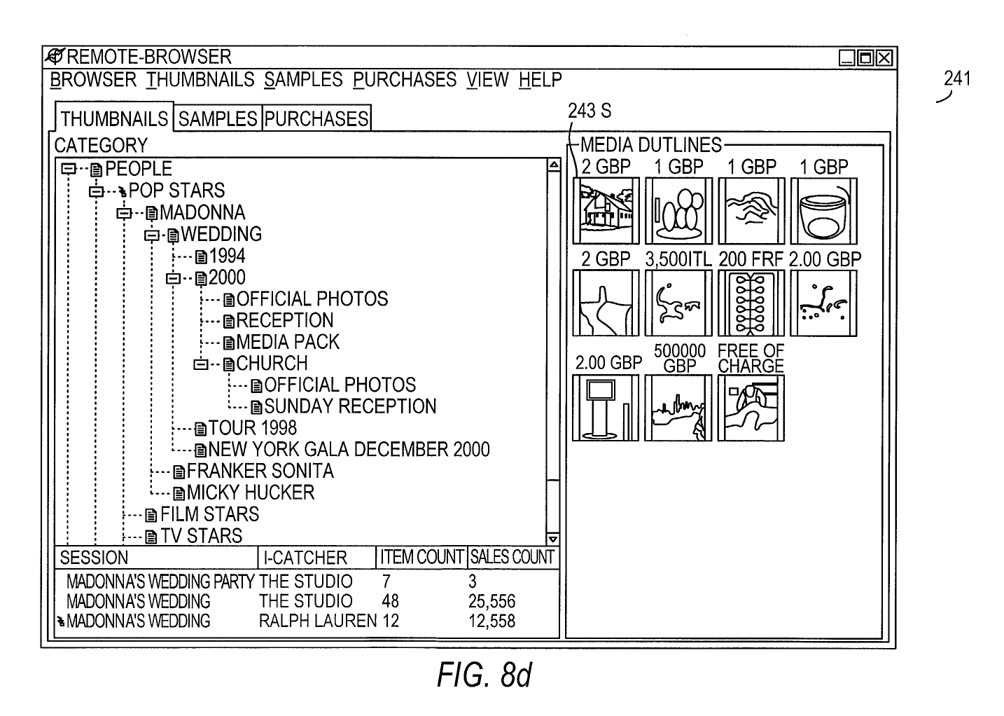

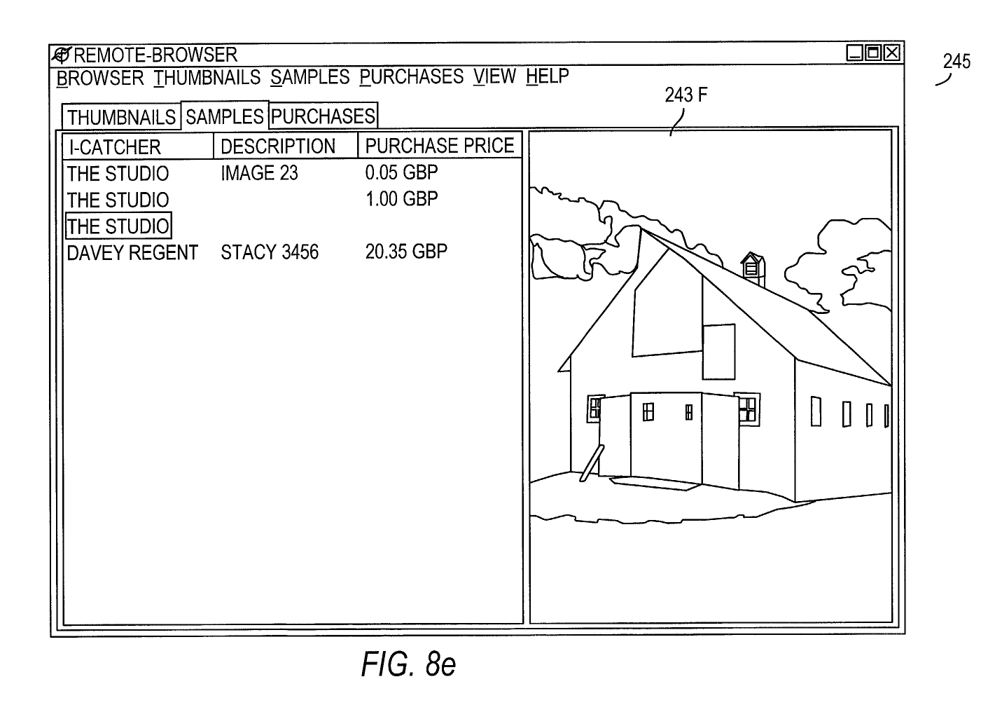

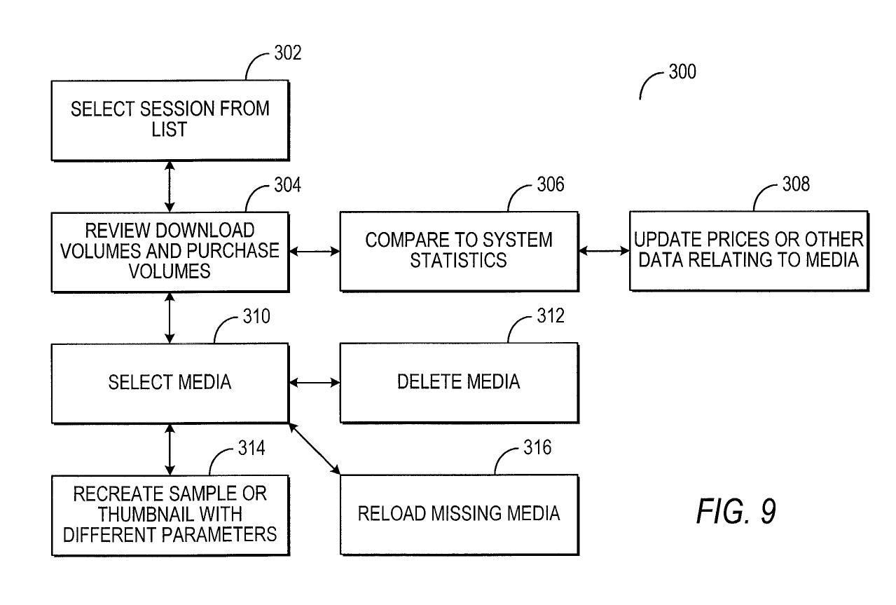

To allow the users an ability to evaluate large quantities of multimedia data units or files the present invention provides functionality that allows browsing of the data based on category of such data. Categories of data were described above with reference to FIG. 5b. The category might be for example a particular catcher, e.g., all data uploaded by a particular catcher, a location where the multimedia data was captured, e.g., Switzerland or Zurich. Keywords describing multimedia may also be used as category. The browsing is performed by process 180 shown in FIG. 8a. In step 182 the process 180 running on computing devices 16, 18 (FIG. 1) may determine whether the device has been used to run the process 180 in the past.

If in step 184 it is determined that the computing device possesses user access information, such information is used in step 186 to log the user in to the exchange computing device 12 via data path 11. Alternatively if the computing device is not in possession of such information, in step 188 the user is asked to fill it in. In step 190 the user may request to use anonymous login, which will allow the user to browse the exchange without the ability to make purchases. The parameters for anonymous browsing are setup in step 192. In step 194 additional parameters are setup to allow the user access to data according to a rating.

In step 196 pre-registered users are identified, after which, in step 198 the process 180 determines the particular user language, and in step 200 the terminal display of the computing device used is set according to preferences as represented in a screen shot 199 shown in FIG. 8c. In step 204 user is allowed to change his or her preferences, these users who decide to provide new preferences may do so in step 206, which step also stores the new preferences in the exchange's database 13. Otherwise the existing user preferences are loaded from the database 13 in step 208.

The users who are not registered with the exchange, i.e., do not have a database record described with reference to FIG. 5a, are asked to provide a unique id, e.g., an e-mail account, in step 210. At this point, in step 212, users may select to provide additional information, which will be accepted and stored in step 214. In step 216 all provided new user information will be stored on all local exchanges 12a-12d (FIG. 3).

In step 218, the user selects the display method that determines the branching the process 180 will take in step 220. If the user selected to view by category, the categories and subcategories are listed in step 222. If view by keyword is selected, the multimedia data matching the selected keyword is searched out in step 224. All multimedia supplied by a selected contributor will be listed in step 226. All the data alternatively selected in steps 222, 224, and 226 is then displayed to the user in step 228.

Referring now to FIG. 8b, the thumbnails of the selected multimedia data are retrieved by the process 180 and displayed to the user in step 240 as represented by screen shot 241 shown in FIG. 8d. Some units are selected by the user for immediate or delayed retrieval in step 242. For example if the thumbnail of a house 243S (FIG. 8d) is selected, the full multimedia data unit 243F (FIG. 8e) will be selected for retrieval. In step 244 the samples are forwarded to the user. In step 246 the user reviews the downloaded samples and in step 248, their prices. In step 250 approved samples may be added to a running tally of a purchase order. In step 262 the user may review the purchase order and download pre-authorized selections in step 264. After acknowledging orders in step 266, the user may pay for the order in step 268.

In steps 270, 272 and 274 the user is enabled to check his or her account balance, review present and past transactions. In steps 276, 278, 280, 282 and 284 account balances may be adjusted and after authorizing the purchase in step 286 the purchased multimedia data unit or units may be selected for download in step 288 and downloaded in step 290.

Review

To allow the users an ability to review and evaluate their accounts, i.e., history and amount of purchases for the masters and sales for the catchers, the present invention provides functionality that allows review of the historical and financial data. Additionally the review process 300, shown in FIG. 9, allows the catchers to change prices of their submission or to remove unpopular multimedia data units. To encourage such removals, the exchanges may charge individual catchers for space and maintenance of the multimedia data submitted.

Process 300 provides a list of past sessions to the reviewing user who, in step 302, selects one or multiple sessions for review and/or comparison. Each session consists of upload and purchase volumes, i.e., the multimedia data units uploaded by the catcher during one uploading session and the purchased multimedia data units from a particular uploading session. In step 304 the user selects the volume for review and compares to overall exchange statistics in step 306, which allows the user to adjust the asking prices in step 308. Alternatively, the user may proceed to step 310 where he/she selects one or more multimedia data units for deletion, achieved in step 312, updates or reloads achieved in step 316, and/or recreation of thumbnails to better represent the data in step 314..

### EXAMPLES

1) The inventive system can be used to avoid traffic jams. A driver can ask a passenger to check whether they should exit on Porte Maillot or La Defense? By using a hand held computing device 16 (FIG. 1), logging on to the exchange 12, and using voice commands the passenger provides the locations of interest data. After possibly agreeing to pay the viewing fees, which may be automatically charged, e.g., to the phone bill, the media data of the requested exit locations is streamed to the computing device 16. During the wait for the requested content a brief flash advertisement with a latest offer may be shown. After viewing the real time traffic conditions at the two exits the driver decides to exit at La Defense due to apparent congestion at Porte Maillot thereby possibly saving 20 minutes or more.

2) A CEO of a company has to make a decision on whether to use the conference facilities of Hotel Yokohama or Hotel Okinawa in Japan for an important presentation. Instead of sending someone there, at a large expanse, he decides to use the exchange 12 (FIG. 1). A local catcher is immediately made available or an advanced booking may be arranged. The CEO slides his credit card through the card reader on his 3G Kanio Communicator to pay the connection fee and begins issuing directions to the catcher. The catcher receives his audio delivered instructions via his 2.5G/3G cell phone that simultaneously doubles as a digital camera. The CEO instructs the catcher to move the phone around in both hotels' conference centers while continuously asking the catcher questions about the facilities available or takes a closer look at various features.

The CEO may get a good impression of the acoustics and from the background sounds. The multimedia feed is routed via the exchange 12 where it is stored in the database 13 enabling future review and reference as needed by the CEO. The feed may be received on a desktop computing device where it could be instantaneously compared to an alternative site. The total transaction costs for the session is a fraction of the cost in money and time for sending a person.

3) A prospective tourist is at his travel agent and decides to go on vacation in Cannes. He finds out that two hotels, Majestic and Martinez, have bargains available, and an immediate decision must be made. Before committing, facilities at the two hotels may be compared via the exchange 12 using for example a 3G cell phone. This is achieved by logging on to the exchange 12 and entering a request naming the two hotels. Almost instantaneously or after a flash advertisement possibly for an airline, the tourist is notified that there are three features available for Majestic and two for Martinez. The tourist makes the selection and reviews features of interest.

4) It's Formula 1 racing day but unfortunately a racing enthusiast couldn't watch the Silverstone Grand Prix live because of personal obligations. However, while attending to the personal matters, the racing enthusiast may use the exchange's special service permitting the race to be watched real-time through the audio enabled web cam mounted on one racer's car.

5) A shipping company has just experienced an emergency as one of its cargo vessels ramrnmed the quay side in Kobe, Japan, where it was supposed to unload its cargo. The company does not have any representatives on the location but has to come with an immediate damage assessment. By using the present invention (1) a session is booked with a local catcher possessing a digital camcorder to ensure quality recording to be on location in 45 minutes; (2) the damage is being visualized immediately by utilizing a satellite service catcher. Received satellite picture of the damaged vessel may be immediately printed out to be included in any damage report. The company may request additional shot with increased resolution of particular section of the original picture. 40 minutes later, the local catcher with the camcorder may provide the viewing of the internal damage according to instructions by the company received by phone. A Bluetooth enabled camcorder dynamically transfers any video/audio and possibly infrared data to the company via the cellular, telephone, Internet network infrastructures. From the sound of the vessel's engine the company specialists may deduct if any damage has occurred there as well.

6) A person and her friends are contemplating going out. However they cannot agree on the most fun place without checking out all four of their favorite places, which will take at least 90 minutes plus the taxi fares. The person using computing device 16 logs on to the exchange 12. After requesting live displayed web cam pictures from the four destinations the person and her friends are able to determine from the size of the crowd outside and the sound of music on the inside of the selected places, where they would rather be.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

Having thus described our invention, what we claim as new, and desire to secure by letters patent is:

1. A method of exchanging multimedia data among at least one master and a plurality of catchers over an electronic network of computing devices, the data being exchanged among a plurality of computing devices connected to the network, at least one of the plurality of computing devices performing functionality of an exchange, the method comprising the steps of:
preparing by the master of at least one tender for requesting multimedia data of interest and submitting said tender to one or more of the plurality of catchers;
acquiring and uploading by the one or more of the plurality of catchers said requested multimedia data to the exchange; and
selecting by the master among said uploaded multimedia data by downloading said selected multimedia data from the exchange.

2. The method of claim 1, further including a step of registering a plurality of users, said plurality of users being indexed as the master and/or as a catcher of said plurality of catchers.

3. The method of claim 2, wherein the step of preparing and submitting said tender further including steps of:
creating a data path over the network between the exchange and one of the plurality of computing devices used by the master;
presenting said tender to said exchange by e-mail or posting on exchange's web page; and
selecting one or more of the plurality of catchers to whom said tender should be routed and routing said tender to the selected catchers.

4. The method of claim 3, wherein the step of routing is performed by e-mailing said tender to the selected catcher or posting said tender in an electronic mail box of the selected catcher on a web page of the exchange.

5. The method of claim 4, wherein said step of acquiring and uploading further includes the steps of:
recording said multimedia data by the one or more catchers according to a request outlined in said tender prepared by said master;
creating thumbnails and descriptions for each unit of said multimedia data; and
uploading said recorded multimedia data and said thumbnails and descriptions to said exchange.

6. The method of claim 5, wherein said step of recording further including the step of directing in real-time by the master of the catcher in recording of said requested multimedia data.

7. The method of claim 5, wherein the step of selecting further including the step of listing all the multimedia submitted in reply to said tender and all the multimedia that was uploaded to the exchange in the past and is equivalent to the tender.

8. The method of claim 7, further including the step of setting a price for each unit of said submitted multimedia data by the plurality of catchers.

9. The method of claim 8, further including the steps of:
billing the master with said set price of said selected and downloaded multimedia data; and
crediting the one or more catchers with the price of said selected submitted multimedia data.
